(19) United States
(12) Patent Application Publication
(10) Pub. No.: US 2008/0294559 A1
(43) Pub. Date: Nov. 27, 2008

(54) Transmission of Anonymous Information Through a Communication Network

(76) Inventors: Gary Wield, Western Australia (AU); Karan Malkani, Cannes (FR)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/630,072

(22) PCT Filed: Jun. 28, 2004
(86) PCT No.: PCT/EP04/07144

§ 371 Date: Feb. 5, 2008

(51) Int. Cl. H04L 29/06

(52) U.S. Cl. 705/50

(57) ABSTRACT

A system that enables anonymous data collection from Respondents, such as over the Internet using public key technologies, where the anonymity and authenticity of Respondents is provided by a trusted mediation service. The invention provides a simple and secure solution that allows authentication of research Respondents while maintaining their anonymity. The Collector cannot link Respondent's real identification and their responses, and a Mediator provides a communication service but has no access to the content of information exchanged between the Respondents and the Collector. According to one aspect of the invention, a Collector requests a list of anonymous Ids from the Mediator. The Mediator then generates a list of anonymous tokens which can then be used by the Respondents when they communicate with the Collector through the Mediator.

### RELATED APPLICATION(S)

This application claims priority under 35 U.S.C. § 119 [and/or § 365] to European Patent Office Application Number EP 03300082.9, filed 7 Aug. 2003 entitled “Transmission of Anonymous Information Through a Computer Network”. The entire teachings of the above application(s) are incorporated herein by reference.

### TECHNICAL FIELD OF THE INVENTION

The invention relates in general to the collection of data from a selected group of Respondents that must remain anonymous, and in particular to an electronic data collection system having an architecture that allows Respondents to communicate responses securely and anonymously over a global communications network such as the Internet.

### BACKGROUND OF THE INVENTION

There are a wide range of applications and situations that benefit from the ability to collect data anonymously, including medial records, social research, employee satisfaction surveys, and the like. Market research is one such industry. It is founded on the belief that a company that knows what its customers really want has a better chance to meet their requirements. Market research is a complicated process that is usually carried out by specialized market research firms (Collectors). The customer of the market research firm can be a manufacturer, a service company or government organization. Research participants (Respondents) must be carefully selected so that they adequately represent the target population. Formulating the questions so that they do not lead or influence the Respondents requires great expertise on behalf of the research company. Care must also be taken so that the questions do not lead to the discovery of the Respondent's real identity.

For other products and services, such as health products or for social research, it can be necessary to ask questions that the Respondent may find very personal and sensitive. Before responding to any such questions the Respondent may wonder if he really is anonymous. If he has the slightest doubt about this, the Respondent will either not answer the question, just fabricate a “likely” answer, a socially acceptable answer or simply an answer the respondent would like you to believe. Either outcome is unsatisfactory for the Collector and his customer who has invested in the research to obtain accurate information.

Much of the complexity and costs of performing research on people therefore, arises from the need to protect the privacy of the Respondents. This usually involves rigorous methodology, secure handling and storing of the information, trusted and trained research employees. The Respondent has no facilities to check that his anonymity is kept intact and must therefore have faith that the Collector has done all the things necessary to protect his anonymity. Small mistakes on behalf of the Collector can lead to accidents where sensitive private information end up in the wrong hands. There are also countless covert methods that an unethical Collector could use to code seemingly anonymous response forms to allow linkage of results with real identities.

Despite all the efforts made by prudent research companies to ensure anonymity, many Respondents will be aware of the risks and find it difficult to trust in their anonymity.

In the case of face to face interviews with Respondents, anonymity is not an option. The Internet now conveniently permits access by large segments of the population to customized data collection systems. These systems allow remote data collection from Respondents by filling in electronic question forms (web pages) or even by conducting on-line interview using chat or voice. The research company must be sure that the Respondent is a valid member of the sample group (called the authentication requirement) and the Respondent must be sure that the Collector has no way of knowing his real identity (the anonymity requirement). In addition, both want to be sure that the communications cannot be intercepted on the Internet or the identity of the originating computer discovered by tracing the IP address.

In some cases a one-off snapshot data collection provides sufficient information for the purpose of the research but in other cases it may be necessary to re-visit all or some of the Respondents for some new information. This must be possible without knowing the real identity of Respondents (anonymous interaction).

There have been efforts in the past by some to protect the integrity of network communications. For example, U.S. Pat. No. 6,185,683 issued to InterTrust teaches a scheme for delivering items from a sender to a recipient electronically via a trusted “go-between” server. The go-between server can validate, witness and/or archive transactions.

In addition, U.S. Patent Application No. 2002/0077887 filed by IBM Corporation describes a system for electronic voting over the Internet. A voting entity (voter) requests a ballot using a public key and a private key. A request to vote is made to a voting mediator. Using a separate private/public key pair, the voting mediator validates the voting request and generates a ballot. The voting mediator sends this ballot to the voter, the voter casts a vote, and then sends the ballot to a voting tabulator. The voting tabulator validates ballots and counts votes.

### SUMMARY OF THE INVENTION

### Statement of the Problem

There is a clear need for a solution that allows for secure authentication and anonymity of Respondents. Unfortunately, the prior art systems are not suitable for interactive, bidirectional communication that may take place over a period of time or even in the context of multiple sessions.

Furthermore, the prior art does not recognize the need to maintain the anonymity of certain aspects of the Respondent, such as an Internet Protocol (IP) address of the Respondent's machine.

For example, while certain prior art systems such as the systems described in U.S. Patent Publication 2002/0077887 do have a “voting mediator”, the purpose of that component is to assure voting by an authorized person. That system does not address the problem of maintaining the anonymity of the voter—indeed it is suggested that the ballots be provided to the voting authority directly by the voter's machines, and thus their IP address can be discovered by examining that message.

This prior art system is also designed as a ballot collection system, and it does not allow real time interaction communication, does not allow multiple sessions, and does not provide other services that are required for longitudinal studies.

Several methods exist for the purpose of hiding IP addresses. Their objective is to provide strong anonymity for a Respondent. Unfortunately, these IP masking methods do not allow a survey Respondent to be contacted on behalf of or by a survey data Collector, and the identity of the Respondent cannot therefore be validated.

Public Key Infrastructure (PKI) based systems have been implemented to encrypt information to prevent access by unauthorized persons, and to authenticate the Respondents in a communication. However, the use of key-based encryption alone is in some important ways, the very antithesis of anonymity desired in surveys. PKI systems invariably result in authenticating the identity of all Respondents.

It is an objective of the present invention to provide a new method and system for data collection in research using a global computing network.

It is another objective of the present invention to provide an electronic data collection method and system that is anonymous for the Respondents.

It is another objective of the present invention to provide an electronic data collection method and system that allows the Collector to contact the Respondents without compromising Respondents' anonymity.

It is another objective of the present invention to provide an electronic data collection method and system that allows the Respondents to be authenticated anonymously.

### BRIEF DESCRIPTION OF THE INVENTION

The present invention is a technique for collecting data from Respondents over a wide area computer network and providing such data to a Collector via a Mediator. In one implementation of the invention, a Collector data processing system requests a list of anonymous identifiers (IDs) from a Mediator. Next, a Mediator system generates the requested list of anonymous IDs; and the Mediator then delivers these anonymous IDs to research Respondents to use when contacting a Collector.

The Collector provides the Respondents with at least one token, such as a cryptographic key or some other identification data, that are unknown to the Mediator and cannot be associated by the Mediator with a particular Respondent. The tokens can be forwarded to the Respondents directly by the Collector to the Respondents, or by using an encrypted connection through the Mediator in such a way that the Mediator is not able to read the token values.

After a survey is initiated, the Respondent encrypts data using the token and sends it to the Mediator. The Mediator validates the Respondent's token, matching it against the list of known valid anonymous IDs, to identify valid communication sessions between the Respondent and the Collector.

During the session, the Mediator takes steps to hide the identity of the Respondent from the Collector, by acting as a communication proxy. This can be implemented by controlling access to a Collector service on behalf of the Respondent using the anonymous ID.

Unlike certain other prior art systems, the Mediator is therefore not simply acting as a trusted third party in relaying messages. In those systems, the Mediator was required to know something about the actual identity of the Respondents, such as their IP address or a key. With the present invention, the data Collector can guarantee anonymity to the Respondents, since the Mediator need not know any actual identification for the Respondents. That is, the Mediator relays messages using anonymous tokens, and does not need to know the information exchanged.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a general view of the relationship between Respondent, Mediator, and Collector data processing systems.

FIG. 2 is a more detailed view of the Mediator system.

FIG. 3 is a more detailed view of the Respondent system.

FIG. 4 is a more detailed view of the Collector system.

FIG. 5 illustrates typical database entries maintained for the Mediator, Respondent, and Collector.

FIG. 6 is a flowchart of operations performed by the Mediator, Respondent, and Collector.

### DETAILED DESCRIPTION OF THE INVENTION

A description of a preferred embodiment of the invention follows.

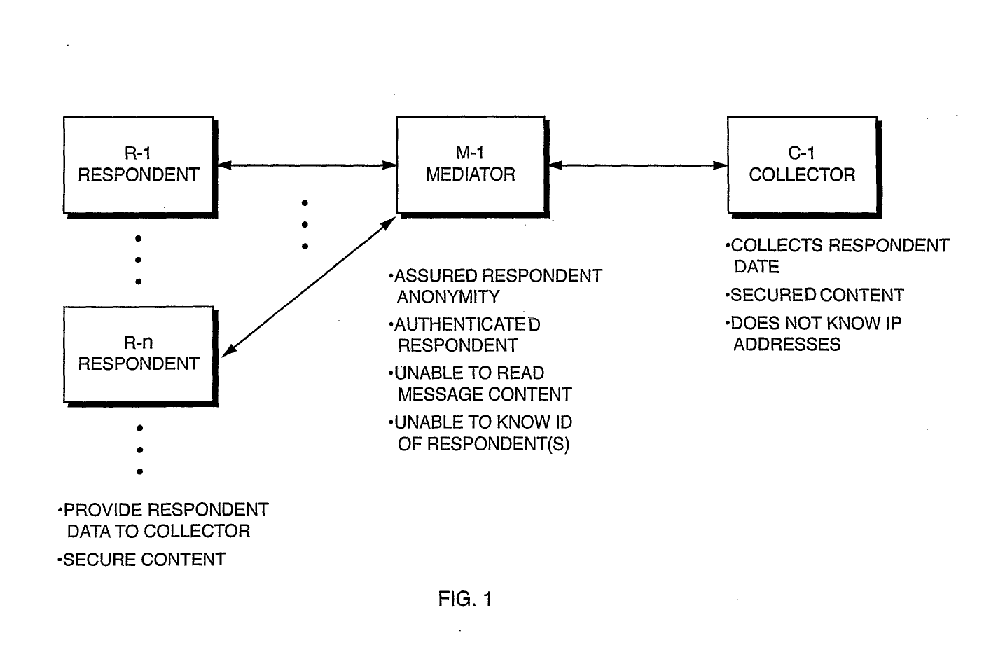

FIG. 1 shows a broad overview of a process for implementing anonymous and secure communication between one or more unique users (“Respondents”) via access through a mediator site (“Mediator”) to a collector service (“Collector”). The technique can be used to conduct confidential customer surveys, voting, and the like. For example, the Collector might be a product manufacturer, consumer service provider, medical researcher, market research company, government entity, voting entity, or the like. The Respondent(s) are typically data providers of the Collector, Respondents in a survey, voters in an election, or other individuals who have been asked to provide responses to questions (or other information) presented by the Collector.

It should be understood that the Mediator, Collector, and Respondent are implemented as data processor systems interconnected by a computer network such as the Internet. Each of these data processors may be any suitable type of data processor. Typically the Respondent system is a personal computer, hand held computer, personal digital assistant, data-enabled mobile phone, or device suitable mainly for data entry. The Mediator is typically a more complicated data processor, and may consist of one or more personal computers and/or file servers, and internetworking devices such as firewalls and routers. The Collector is also typically a data processor such as a personal computer and/or file server.

A group of anonymous Respondents, R-1, . . . , R-n, communicate with a Collector, C, through a Mediator, M, to provide responses to information presented by the Collector. Although only one is shown in the drawing of FIG. 1, there can also be many Collectors, each of them communicating with groups of anonymous Respondents through the Mediator.

Messages are handled in such a way as to preserve the anonymity of the Respondent. For example, the Mediator is able to perform its assigned tasks of forwarding messages to the Collector without having to know the actual identity of the Respondent. The Mediator also takes further steps to hide the Respondents' real identity {name, registration number, or other identification (ID) information such as Internet Protocol (IP) address} from the Collector.

In addition, steps are taken to ensure that the content of the communication between Respondent and Collector is encrypted, so the Mediator cannot access it, and so that only the Respondent and the Collector are capable of knowing the information that is exchanged.

Before discussing several possible implementations of the invention in detail, its general attributes will be discussed. A Respondent may take an initial step by sending a registration request to a Mediator. The Respondent can be determined by the Mediator to be a member of the Collector's panel/respondent database, since the Mediator has previously been informed by the Collector, and/or by having the Mediator send a query to the Collector's database in response to a registration request.

Once Respondents have been recognized as authorized users or members of the Collector's service, the Respondents are anonymously connected to the Collector, and can then access different independent Collector services through the Mediator. During this session, the Mediator hides the real IP address of the Respondent from the Collector. To accomplish anonymity, as part of granting access, the Collector receives an anonymous token from the Mediator that is used to initiate and maintain a session between the Respondent and the Collector. An anonymous token is also presented to the Collector as proof that the Respondent is a valid one. This token can also be used to enable anonymous longitudinal studies and long-term behavior studies. The token can be a cryptographic key, or can be some other piece of information, such as a random number that can be associated with the Respondent.

To assure that the content cannot be read by the Mediator, a Respondent encrypts data intended only for the Collector. In particular, the Respondent knows or is given a public key of the Collector. The Respondent then uses that key to encrypt any information he sends to the Collector. This eliminates any possibility for the Mediator (or any other third party) to know what information is being transferred between the Respondent and the Collector.

Similarly, the Collector knows or is given the Respondent's public key to encrypt information intended for the Respondent. It should be ensured that the Respondent's public key is not linked to his real identity in any way, so that the Respondent remains anonymous to the Collector.

The Mediator thus acts as a communication proxy, serving to hide the Respondent's Internet Protocol (IP) address from the Collector, which otherwise could compromise his anonymity, while still serving as the link for the above encrypted transfer of information between the Respondent and the Collector.

The Collector can then ask the Mediator to contact an anonymous Respondent by using the Respondent's token. The Mediator will forward the request, which can be encrypted by Collector, to the correct Respondent.

The role of the Mediator is thus to
authenticate the Respondent as a valid respondent to Collector
use the anonymous token system when communicating with the Respondent, thereby eliminating the need to know the identity of the Respondent
anonymize the IP of the Respondent with respect to the Collector, with an IP relay/proxy system
ignore the content exchanged between the Respondent and the Collector
certify the participation of a Respondent to a study managed by the Collector
contact the Respondent on behalf of the Collector
contact the Collector on behalf of the Respondent
guarantee to the Respondent that anonymity will be respected
   The way that anonymity is maintained is to observe that
The anonymity of the method grows with the number of participating respondents.
The Respondent is always a member of a group of n Respondents.
The Group may be selected by the Collector, and thus he may know the members. In that case, the invention serves to prevent to Collector from knowing which one of the Respondents gives which response.
The Group may be selected by the Mediator, by using some criteria, agreed by Collector. The Collector will not know the Respondents. There is still a need to prevent the Collector from learning the IP addresses, provide authentication of group members etc.

Table A summarizes the information that Respondents, Mediator, and Collector “know” about one another.

TABLE A
Table of Knowledge/Anonymity

| | Respondent knows | Mediator knows this | Collector knows this |
|---|---|---|---|
| | this about the . . . | about the . . . | about the . . . |
| . . . Respondent | | anonymous ID | may have a list of |
| | | only | all Respondent but |
| | | membership to | cannot identify a |
| | | Collector | specific one when |
| | | anonymous token | connected over the |
| | | of the Respondent | Mediator |
| | | does NOT know | anonymous token |
| | | information | of the Respondent |
| | | exchanged between | Respondent's |
| | | Respondent and | public key that is not |
| | | Collector | linked to his real ID |
| . . . Mediator | its method for | | its method for |
| | anonymity (e.g., | | anonymity (e.g., |
| | using tokens) | | using tokens) |
| . . .Collector | Collector's public | the anonymous | |
| | key | tokens of the | |
| | | Collector's members | |

Table B summarizes the information that the various system elements are prevented from knowing about one another.

TABLE B
The “Does not Know” Table

| | Respondent does | | |
|---|---|---|---|
| | NOT know this | Mediator does NOT | Collector does NOT |
| | about the . . . | know this about the . . . | know this about the . . . |
| . . . Respondent | | the content | the link between |
| | | exchanged with the | the Respondent and |
| | | Collector | his information |
| | | | IP address |
| . . . Mediator | not applicable | | not applicable |
| . . . Collector | not applicable | the content | |
| | | exchanged with the | |
| | | Respondent | |

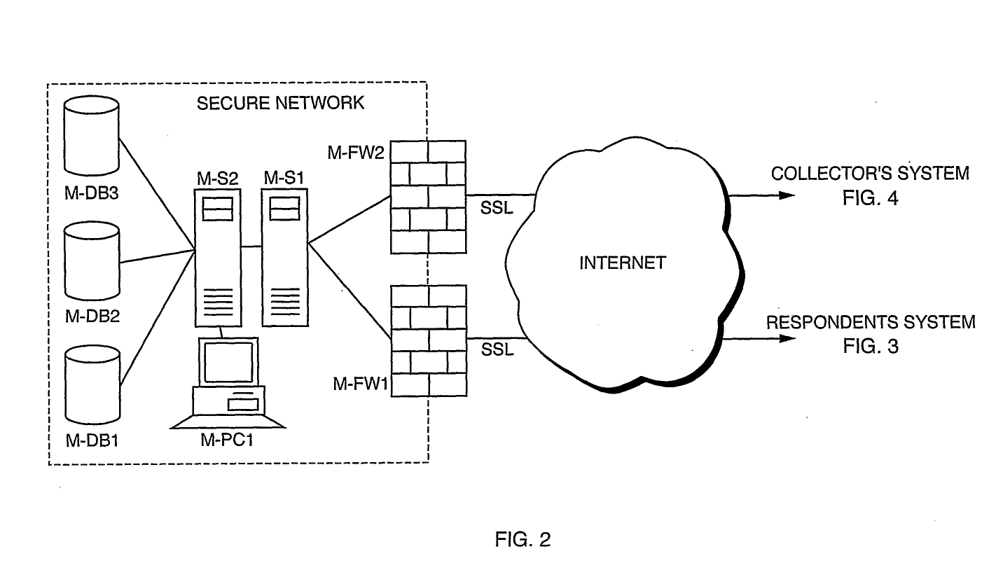

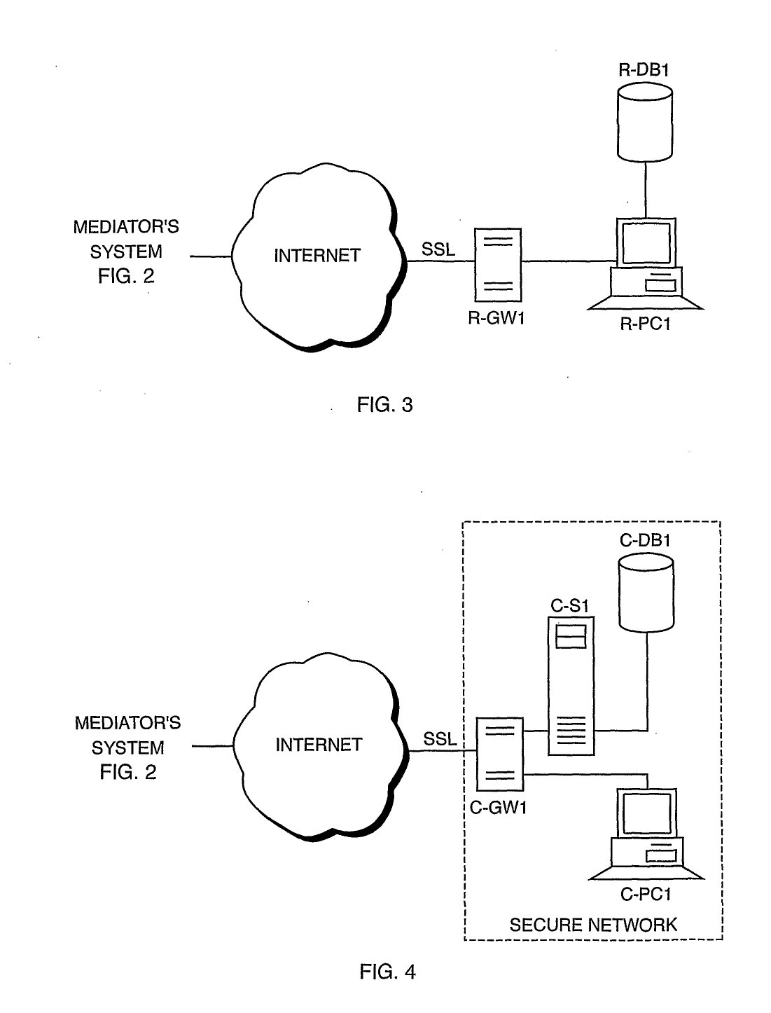

FIG. 2. presents minimum requirements for a typical Mediator system, M. The Mediator consists of various servers, databases, other processors, and firewalls connected to the Internet, all within a secure network. Secure Socket Layer (SSL) services are typically used to establish secure connections between the various entities over the Internet. That is, secure connections are provided to both the Collector system and Respondent system(s).

In the illustrated embodiment, M-FW1 and M-FW2 are firewalls, one for handling communication with Collectors and the other for communication with Respondents. It should be understood that other implementations of firewalls and secure network systems are possible.

A first server, M-S1, acts as a message router and proxy to examine message traffic received from a Respondent. M-S1 replaces a Respondent's actual Internet Protocol (IP) address in each message with another one (possibly the real IP address of the Mediator), prior to forwarding the message to the associated Collector. This prevents the Collector from tracing the actual IP address of Respondent.

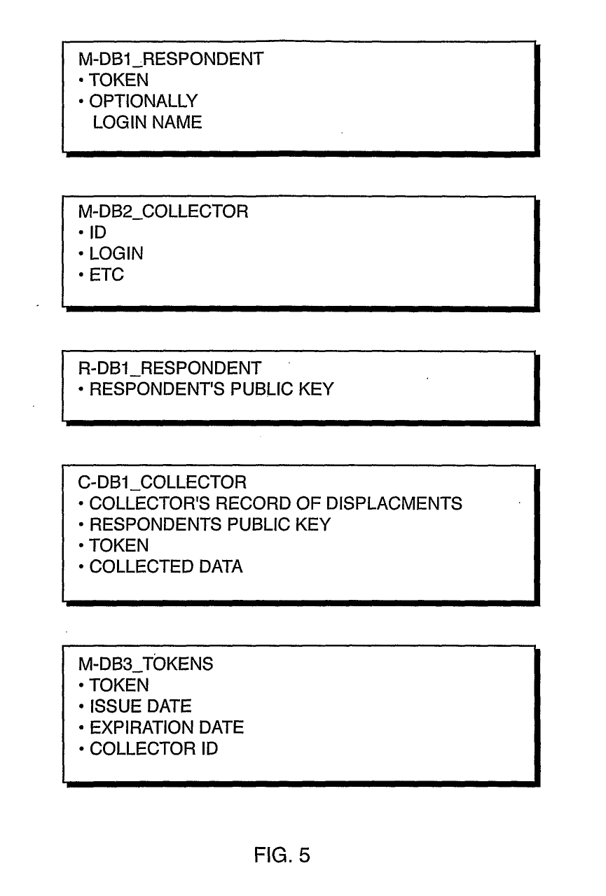

A second server, M-S2, is an application and web server that are required to manage Respondents and Collectors accounts. For example, this server maintains databases that are required to store information on Respondents, Collectors and their associated IDs and tokens. Key database records are described below in connection with FIG. 5. M-PC1 is a local (or remote) Personal Computer that can be used to administrate and monitor the Mediator system.

FIG. 3 is an overview of the typical Respondent system. It consists of some type of connection to the Internet such as a communication gateway R-GW1, a personal computer R-PC1, and database R-DB1. The gateway R-GW1 maybe any suitable connection to the Internet such as a dial-up modem, cable modem, satellite modem, wireless modem, Digital Subscriber Line (DSL), wired or wireless local area network (LAN) connection gateway, T1/E1 carrier interface, and the like. What is important is that the R-GW1 support SSL encryption, typically over a TCP/IP network connection.

While a desktop computer is illustrated for R-PC1, this can be a portable (laptop), handheld computer, personal digital assistant, data-enabled mobile phone, digital set top box, or any other data processing equipment.

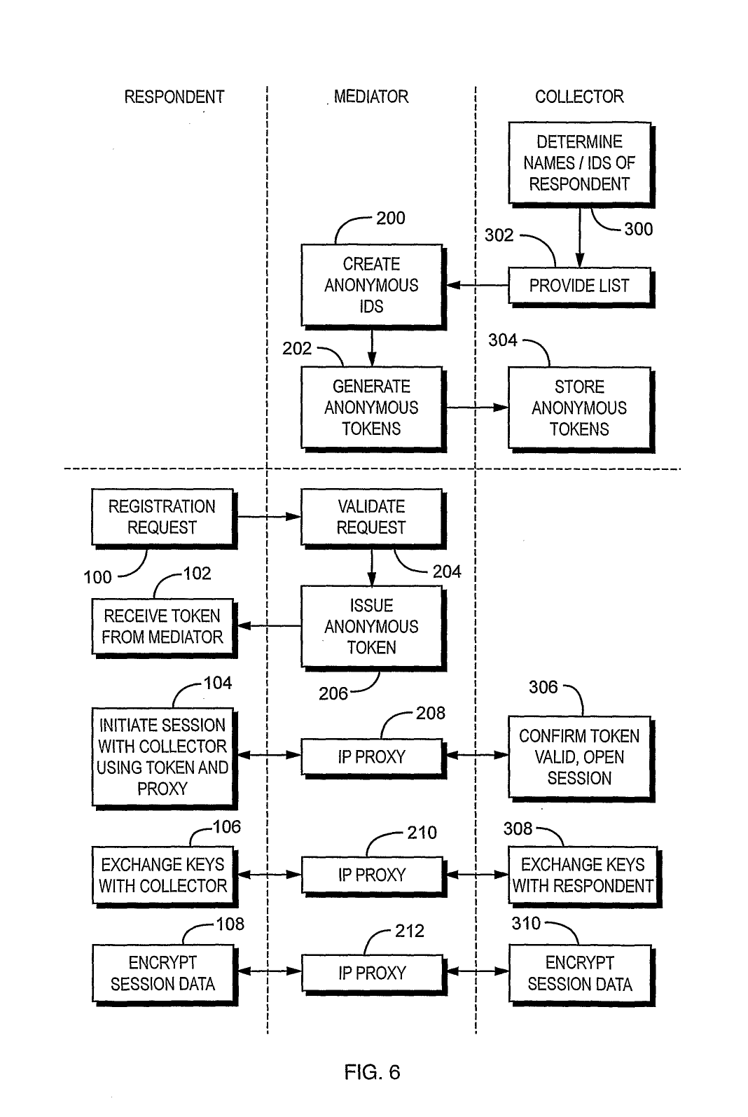

FIG. 4 is a hardware diagram of a Collector system. Similar to the Respondent system, it consists of a Collector gateway C-GW1, Collector processor C-PC1, and database C-DB1. Also used here is a Collector server C-S1, that performs a number of tasks that will be described below in connection with the flowchart of FIG. 6.

FIG. 5 illustrates some of the database entries maintained by the various systems. For example, the Respondent database R-DB1 maintains information such as the Respondent's private and public keys, and/optionally, the Collector's public key. This permits the Respondent to encrypt and decrypt messages sent to and received from the Collector.

The Collector database C-DB1 maintains public keys of the Respondents, its own public and private keys, tokens used to anonymously identify Respondents, and data collected from the Respondents.

The Mediator databases are a bit more complex. In a first database M-DB1 is maintained a list of tokens that are used as anonymous identifiers for the Respondents, and, optionally, user login names and passwords and e-mail addresses for the Respondents. This information is used to authenticate Respondents without compromising their identity to the Collector.

A second database M-DB2 contains identification and login information for Collectors.

A third database M-DB3 is used to coordinate the assignment of tokens to communication sessions between specific Respondents and Collectors. Thus, when requested to allow a communication session to occur, the Mediator maintains a token associated with the session, its issue and expiration dates, as well as an identifier for the Respondent and Collector associated with the session.

FIG. 6 is a flowchart of the steps that are performed in one possible embodiment of the invention. The steps labeled with reference numerals 100-108 are carried out by the Respondent system, the steps labeled with reference numerals 200-212 are carried out by the Mediator system, and steps labeled 300-310 are carried out by the Collector.

A first step 300 involves recruitment of Respondents. This proceeds under control of the Collector, and can occur in a couple of different ways. The Collector can decide on a criteria or list of names defining the group of Respondents. The Collector can then enlist the assistance of the Mediator to recruit Respondents, or the Collector can contact Respondents directly and ask them to register with the Mediator.

In a first registration scenario, depicted in FIG. 6, a list of Respondents is provided to the Mediator in step 302. The Mediator, in step 200, then creates login identifications and other parameters for each Respondent, including at least an anonymous token for each Respondent. The token will be used to identify communication sessions between each particular Respondent and the Collector.

However, in another case (not illustrated in FIG. 6), the Mediator simply issues a requested number of tokens. This can be accomplished by having the Collector ask the Mediator for a number of single-use log-on tokens, which will be at least as many as the number of intended Respondents. The Collector then contacts the Respondents, asking them to register on to Mediator's system, using one of the tokens.

In a third possible scenario (also not shown in detail in FIG. 6) the Mediator recruits Respondents according to criteria set forth by the Collector. Thus, the Collector commissions Mediator to recruit Respondents according to some criteria, the Mediator creates an account for each recruited Respondent, and then the Mediator provides Collector with a list of anonymous tokens.

In any event, upon receiving a request to participate, in step 100, the Respondents register with the Mediator's system. Here, the Respondent logs on the Mediator website using his login name and password. In step 204, the request to login is validated against the list of authorized Respondents, and if validated, the Respondent is issued a token in step 206. The Respondent then stores the token received from the Mediator in step 102.

The Respondent is then granted access to Collector's service by and over the Mediator, by initiating a session in step 104. The Mediator maintains the anonymity of the session by acting as a proxy, in step 208, to hide the real IP number of the Respondent from Collector. As part of granting access, the Collector will receive the anonymous token from the Respondent that is used to initiate (and later, to maintain) the session. This anonymous token is presented to the Collector as proof that the Respondent is a valid one.

The Respondent then exchanges cryptographic keys with the Collector, in steps 106, 201, and 308. In one embodiment, the Respondent uses the Collector's key to encrypt the Respondent's key and then sends the encrypted Respondent's key to the Collector. Note that the IP proxy is still in place even when exchanging keys, so that the anonymity of the Respondent (from the perspective of the Collector) is assured.

Further session data between the Respondent and the Collector are now exchanged in encrypted form (steps 108, 212, and 310) using their respective public keys. No session data can therefore be read by any Internet intermediaries (e.g. ISP) or the Mediator; while at the same time, the identity of the Respondent is protected.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for anonymously collecting response data from Respondent computer nodes connected to a wide area computer network by providing such data to a Collector computer node via a Mediator computer node, the method comprising the steps of:
at the Respondent,
originating response data to ultimately be sent to the Collector;
encrypting the response data so that it cannot be read by the Mediator;
forwarding the encrypted response data to the Mediator as an anonymous response message;
at the Mediator,
receiving the response message;
authenticating the source of the response message as being a member of a group of authorized Respondents, without compromising the anonymous identity of the Respondent;
forwarding the response message to the Collector as an authenticated response;
at the Collector;
receiving the authenticated message; and
decrypting the response data so that it can be read.

2. A method as in claim 1 wherein the Respondent's identity is not included in the Response message.

3. A method as in claim 2 additionally comprising determining an anonymous identifier (ID) to be used by the Respondent to indicate itself as a source of the response message.

4. A method as in claim 3 wherein the anonymous ID is generated by the Collector.

5. A method as in claim 1 additionally comprising the steps of:
at the Collector,
determining a list of multiple authorized Respondents;
at the Mediator,
generating a corresponding list of anonymous tokens, with at least one token associated with each authorized Respondent.

6. A method as in claim 5 additionally comprising the steps of:
at the Respondent,
originating a registration request message;
forwarding the registration request message to the Mediator;
at the Mediator,
receiving the registration request message;
assigning an anonymous token to the Respondent that originated the request message; and
forwarding the anonymous token to the Respondent.

7. A method as in claim 6 additionally comprising the step of:
at the Respondent,
originating a response message including the anonymous token;
at the Mediator,
receiving the response message;
forwarding the response message to the Collector.

8. A method as in claim 7 wherein the Collector additionally validates the token upon receipt of the response message from the Mediator.

9. A method for collecting data from Respondents over a wide area computer network and providing such data to a Collector via a Mediator, the method comprising the steps of:
at the Collector,
requesting a list of anonymous identifiers (IDs) from a Mediator; at the Mediator,
generating a list of anonymous IDs; and
delivering an anonymous ID to research Respondents to use when contacting a Collector;
then, back at the Collector,
providing a Respondent with an anonymous ID to use to send data to the Collector via the Mediator, but in a manner which prevents the Mediator from associating the anonymous ID with the Respondent's real identity.

10. A method as in claim 9 additionally comprising:
at a Respondent,
originating a request to participate in a survey,
at a Mediator,
receiving the survey request from the Respondent;
validating the Respondent using data provided by a Collector, including at least the anonymous ID to identify communication sessions between the Respondent and the Collector; and
controlling access to a Collector service on behalf of the the Respondent using the anonymous ID.

11. A method as in claim 10 additionally comprising the steps of:
at the Respondent,
originating a message containing survey data;
receiving the Collector's public key;
generating a public key for the Respondent; and
securely communicating the Respondent's public key to the Collector using the Collector's public key.
